(19) United States
(12) Patent Application Publication
(10) Pub. No.: US 2022/0138424 A1
(43) Pub. Date: May 5, 2022

(54) Domain-Specific Phrase Mining Method, Apparatus and Electronic Device

(71) Applicant: Beijing Baidu Netcom Science Technology Co., Ltd., Beijing (CN)

(72) Inventors: Xijun GONG, Beijing (CN); Zhao LIU, Beijing (CN); Rui LI, Beijing (CN); Ruifeng LI, Beijing (CN); Haihao TANG, Beijing (CN)

(21) Appl. No.: 17/574,671

(22) Filed: Jan. 13, 2022

(30) Foreign Application Priority Data
Mar. 23, 2021 (CN) 202110308803.3

(51) Int. Cl. G06F 40/289; G06V 30/19

(52) U.S. Cl. CPC G06F 40/289; G06V 30/19107; G06V 30/19093

(57) ABSTRACT

A domain-specific phrase mining method, apparatus and electronic device are provided. A specific implementation includes: performing word vector conversion on a domain-specific phrase in a target text to obtain a first word vector, and performing word vector conversion on an unknown phrase in the target text to obtain a second word vector, where the domain-specific phrase is a phrase in a domain to which the target text belongs; obtaining a word vector space formed by the first and second word vectors, and identifying a preset quantity of target word vectors around the second word vector in the word vector space; determining, based on similarity values indicative of similarity between the preset quantity of target word vectors and the second word vector, whether the unknown phrase is a phrase in the domain to which the target text belongs.

### CROSS-REFERENCE TO RELATED APPLICATION

The present application claims priority to the Chinese patent application No. 202110308803.3 filed in China on Mar. 23, 2021, the disclosure of which is incorporated herein by reference in its entirety.

### TECHNICAL FIELD

The present disclosure relates to the field of computer technology, in particular to the field of language processing technology. Specifically, the present disclosure relates to a domain-specific phrase mining method, apparatus and electronic device.

### BACKGROUND

Since domain-specific phrases can represent the characteristics of a domain, and can be distinguished from features of other domains, domain-specific phrase mining has become one of fundamental tasks in word processing. With the rapid development of Internet technology, contents produced by online users are widely spread and mined, and new phrases and vocabularies are continuously emerging, the domain-specific phrase mining has become an important task in the content mining field.

### SUMMARY

The present disclosure provides a domain-specific phrase mining method, apparatus and electronic device.

According to a first aspect of the present disclosure, a domain-specific phrase mining method is provided. The method includes: performing word vector conversion on a domain-specific phrase in a target text to obtain a first word vector, and performing word vector conversion on an unknown phrase in the target text to obtain a second word vector, where the domain-specific phrase is a phrase in a domain to which the target text belongs; obtaining a word vector space formed by the first and second word vectors, and identifying a preset quantity of target word vectors around the second word vector in the word vector space; determining, based on similarity values indicative of similarity between the preset quantity of target word vectors and the second word vector, whether the unknown phrase is a phrase in the domain to which the target text belongs.

According to a second aspect of the present disclosure, a domain-specific phrase mining apparatus is provided. The apparatus includes: a conversion module, configured to perform word vector conversion on a domain-specific phrase in a target text to obtain a first word vector, and perform word vector conversion on an unknown phrase in the target text to obtain a second word vector, where the domain-specific phrase is a phrase in a domain to which the target text belongs; an identification module, configured to obtain a word vector space formed by the first and second word vectors, and identify a preset quantity of target word vectors around the second word vector in the word vector space; a determination module, configured to determine, based on similarity values indicative of similarity between the preset quantity of target word vectors and the second word vector, whether the unknown phrase is a phrase in the domain to which the target text belongs.

According to a third aspect of the present disclosure, an electronic device is provided. The electronic device includes at least one processor and a memory in communicative connection with the at least one processor, where the memory stores an instruction executable by the at least one processor, and the instruction, when being executed by the at least one processor, causes the at least one processor to implement the method according to the first aspect.

According to a fourth aspect of the present disclosure, a non-transitory computer readable storage medium storing thereon a computer instruction is provided. The computer instruction is configured to be executed by a computer to implement the method according to the first aspect.

According to a fifth aspect of the present disclosure, a computer program product including a computer program is provided. The computer program is configured to be executed by a processor to implement the method according to the first aspect.

It should be understood that the content described in this section is not intended to identify the key or important features of the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are to facilitate better understanding of the solution, and do not constitute a limitation on the present disclosure.

FIG. 1 is a flow diagram of a domain-specific phrase mining method according to an embodiment of the present disclosure;

FIG. 2 is a structure diagram of a domain-specific phrase mining model applicable to the present disclosure;

FIG. 3 is a schematic diagram of example construction of a domain-specific phrase mining model applicable to the present disclosure;

FIG. 4 is a structure diagram of a domain-specific phrase mining apparatus according to an embodiment of the present disclosure;

FIG. 5 is a block diagram of an electronic device for implementing the domain-specific phrase mining method according to the embodiment of the present disclosure.

### DETAILED DESCRIPTION

The following describes exemplary embodiments of the present application with reference to the accompanying drawings, which include various details of the embodiments of the present application to facilitate understanding, and should be regarded as merely exemplary. Therefore, those of ordinary skill in the art should recognize that various changes and modifications can be made to the embodiments described herein without departing from the scope and spirit of the present disclosure. Likewise, for clarity and conciseness, descriptions of well-known functions and structures are omitted in the following description.

The present disclosure provides a domain-specific phrase mining method.

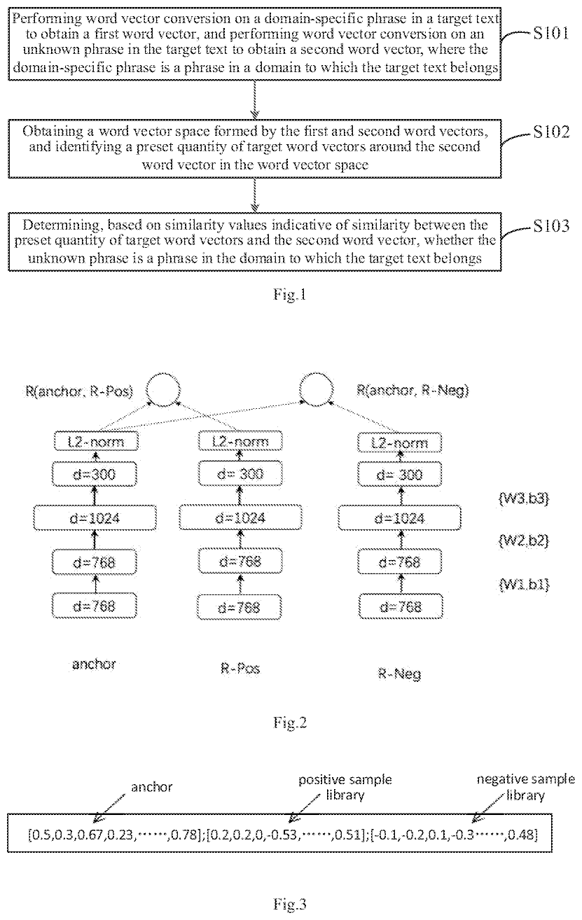

Referring to FIG. 1, a flow diagram of a domain-specific phrase mining method according to an embodiment of the present disclosure is illustrated. As shown in FIG. 1, the method includes a step S101, a step S102 and a step S103.

Step S101, performing word vector conversion on a domain-specific phrase in a target text to obtain a first word vector, and performing word vector conversion on an unknown phrase in the target text to obtain a second word vector, where the domain-specific phrase is a phrase in a domain to which the target text belongs.

It is noted, the domain-specific phrase mining method provided in the embodiment of the present disclosure is applicable to an electronic device, such as a mobile phone, tablet computer, laptop computer or desktop computer.

Optionally, domains to which a piece of text belongs may be classified according to different classifying rules. For example, the domains may be classified in terms of academic discipline, e.g., the domain to which a piece of text belongs may include medical science, mathematics, physics, literature and the like; or the domains may be classified in terms of news theme, e.g., the domain to which a piece of text belongs may include military, economy, politics, sports, entertainment and the like; or the domains to which a piece of text belongs may be classified in other manner, and no specific limitation in this regard is given herein.

In an embodiment of the present disclosure, prior to the step S101, the method may further include: obtaining the target text, and determining a domain to which the target text belongs; obtaining a domain-specific phrase and an unknown phrase in the target text.

Optionally, the target text may be downloaded by the electronic device over a network, or the target text may be text stored by the electronic device, or the target text may be text identified by the electronic device online. For example, the target text may be a research paper downloaded by the electronic device over a network, a piece of sports news displayed in an interface of an application currently run by the electronic device, or the like.

Further, having obtained the target text, the electronic device determines a domain to which the target text belongs. Optionally, the electronic device may identify a keyword in the target text, and determine the domain to which the target text belongs based on the keyword. For example, the target text is a medical academic paper, then it is determined by identifying the keyword in the paper that the paper belongs to medical domain.

In the embodiment of the present disclosure, having determined the domain to which the target text belongs, the electronic device further obtains a domain-specific phrase and an unknown phrase in the target text. The domain-specific phrase is a phrase in the domain to which the target text belongs, and the unknown phrase is a phrase whose affiliation with the domain to which the target text belongs cannot be ascertained. For example, the target text is a medical academic paper, then the target text belongs to medical domain. The phrases such as “vaccine” and “chronic disease” included in the target text are phrases in the domain to which the target text belongs. One cannot ascertain whether the phrases such as “high standard, stringent requirement” and “choke with sobs” in the target text belong to the medical domain, thus the phrases can be classified as unknown phrases. In this way, phrases in the target text can be classified based specifically on the domain to which the target text belongs.

Optionally, having obtained the target text, the electronic device may perform pre-processing, such as word segmentation and word filtering, on the target text. It may be understood the target text is usually made up of several sentences. The word filtering may be performed on the sentences in the target text. For example, conventional words or adjectives such as “we”, “you”, “'s” and “beautiful” may be removed. Then the word segmentation is performed to obtain several phrases. Subsequently, the electronic device identifies whether the phrases are domain-specific phrases or unknown phrases. The word segmentation may utilize a specific word segmentation tool custom library; optionally, new words may be filtered based on mutual information and left-right information entropy in statistics, and added to the word segmentation tool custom library.

It may be understood, with the pre-processing such as word segmentation and word filtering performed on the target text, interferences of conventional words or adjectives to the word segmentation can be avoided, and the accuracy of the word segmentation processing may be improved to obtain the domain-specific phrases and unknown phrases in the target text. It is noted, for the word segmentation processing performed on the text, a reference can be made to the related art. A detailed description of the specific principle of the word segmentation is omitted herein.

In the embodiment of the present disclosure, after the domain-specific phrases and the unknown phrases in the target text are obtained, word vector conversion is performed on the domain-specific phrases and the unknown phrases respectively, to obtain first word vectors corresponding to the domain-specific phrases and second word vectors corresponding to the unknown phrases. Optionally, the word vector conversion refers to converting a word such that the word is represented in form of a vector. For example, the word vector conversion may be implemented based on word2vec (word to vector).

It is noted, in a case that there are multiple domain-specific phrases, there are multiple corresponding first word vectors, wherein one first word vector is derived from word vector conversion performed on one corresponding domain-specific phrase. In other words, a quantity of the first word vectors is equal to a quantity of the domain-specific phrases, and the domain-specific phrases correspond to the first word vectors in a one-to-one manner. Likewise, a quantity of the second word vectors is equal to a quantity of the unknown phrases, and the unknown phrases correspond to the second word vectors in a one-to-one manner.

Step S102, obtaining a word vector space formed by the first and second word vectors, and identifying a preset quantity of target word vectors around the second word vector in the word vector space.

In the embodiment of the present disclosure, after the word vector conversion is performed on the domain-specific phrase and the unknown phrase in the target text to obtain the first word vector and the second word vector, the word vector space formed by the first word vector and the second word vector can be obtained. The first word vector and the second word vector are in the word vector space. Then, the preset quantity of target word vectors around the second word vector are identified. For example, assuming the preset quantity is 10, ten target word vectors closest to the second word vector are obtained. The preset quantity may be preset in the electronic device, or may be modified based on a user operation.

It is noted, the present disclosure encompasses both a case in which the preset quantity of target word vectors around any one second word vector are obtained and a case in which the preset quantity of target word vectors around each second word vector are obtained. The target word vector may include the first word vector, the second word vector and a third word vector resulting from conversion of a conventional phrase. Optionally, the target word vector may only include the first word vector and the third word vector.

Step S103, determining, based on similarity values indicative of similarity between the preset quantity of target word vectors and the second word vector, whether the unknown phrase is a phrase in the domain to which the target text belongs.

In the embodiment of the present disclosure, after the preset quantity of target word vectors around the second word vector are determined, a similarity value indicative of similarity between each target word vector and the second word vector may be calculated, and it is determined, based on the calculated similarity value, whether the unknown phrase corresponding to the second word vector is a phrase in the domain to which the target text belongs.

For example, assuming the preset quantity of the target word vectors are 10, a similarity value indicative of similarity between each target word vector and the second word vector is calculated, and then ten similarity values are obtained. An average of the ten similarity values may be calculated, and it is determined, based on the average, whether the unknown phrase is a phrase in the domain to which the target text belongs. Optionally, a sum of the ten similarity values may be calculated, and it is determined, based on the sum, whether the unknown phrase is a phrase in the domain to which the target text belongs.

It is understood, on the basis of the similarity values indicative of similarity between the preset quantity of target word vectors and the second word vector, either of following conclusions can be made: the unknown phrase is a phrase in the domain to which the target text belongs, or the unknown phrase is not a phrase in the domain to which the target text belongs. In this way, phrases in the target text that fall into the domain to which the target text belongs can be mined, whereby the domain-specific phrases in the domain to which the target text belongs can be expanded.

In the embodiment of the present disclosure, phrases are converted to word vectors and it is determined, based on similarity between the word vectors, whether the unknown phrase is a phrase in the domain to which the target text belongs. In other words, the unknown phrase is identified and determined via a clustering process. The identification of the preset quantity of target word vectors around the second word vector amounts to adding a constraint condition in the clustering process, to prevent the problem of noise amplification caused by adding noise to the clustering cluster. Thus, the accuracy of identification and determination of unknown phrases is improved, and there is no need for an annotation personnel to identify the unknown phrase based on subjective experience, avoiding the impact of a person's subjective experience, such that not only manpower is saved, but also the accuracy of identification and determination of unknown phrases is improved.

Optionally, the method may further include: obtaining a first clustering cluster formed by the first word vector, and obtaining a second clustering cluster formed by a third word vector converted from a preset conventional phrase; obtaining a first distance between the second word vector and a cluster center of the first clustering cluster, and obtaining a second distance between the second word vector and a cluster center of the second clustering cluster.

In this case, the identifying the preset quantity of target word vectors around the second word vector in the word vector space includes: identifying the preset quantity of target word vectors around the second word vector in the word vector space in a case that the first distance is less than the second distance.

It may be understood, in addition to domain-specific phrases that can be determined, the target text includes some conventional words or adjectives such as “we”, “you”, “great” and “beautiful”, which can be referred to as conventional phrases in the embodiments of the present disclosure. The preset conventional phrase may be stored and set by the electronic device in advance, and the preset conventional phrase is not the conventional phrase identified in the target text.

In the embodiment of the present disclosure, the word vector space not only includes the first and second word vectors, but also includes the third word vector resulting from the word vector conversion performed on the preset conventional phrase. After the first clustering cluster formed by the first word vector and the second clustering cluster formed by the third word vector are obtained, the cluster center of the first clustering cluster and the cluster center of the second clustering cluster can be obtained. The cluster center may be an average value of all word vectors included in the clustering cluster, and therefore is also in form of a vector.

Optionally, a first distance between the second word vector and a cluster center of the first clustering cluster is calculated, and a second distance between the second word vector and a cluster center of the second clustering cluster is calculated. It is noted, in this case, any one second word vector is selected as a second target word vector for calculation of the first distance between the second target word vector and the cluster center of the first clustering cluster, and calculation of the second distance between the second target word vector and the cluster center of the second clustering cluster.

Further, the first distance and the second distance are compared. If the first distance is less than the second distance, which demonstrating that the second word vector is closer to the cluster center of the first clustering cluster, since the first clustering cluster is formed by first word vectors, it can be concluded that the second word vector is closer to the domain-specific phrases corresponding to the first word vectors. In this case, the preset quantity of target word vectors around the second word vector in the word vector space are identified, and it is determined, based on similarity values indicative of similarity between the preset quantity of target word vectors and the second word vector, whether the unknown phrase is a phrase in the domain to which the target text belongs.

It is noted, if the first distance is greater than the second distance, which demonstrating that the second word vector is closer to the cluster center of the second clustering cluster, since the second clustering cluster is formed by a third word vector converted from a preset conventional phrase, it can be concluded that the second word vector is more likely a conventional domain phrase. In this case, the unknown phrase is more likely a conventional domain phrase, and is less likely a phrase in the domain to which the target text belongs. Then there is no need to identify the target word vectors around the second word vector, and there is no need to perform the subsequent identification and determination as to whether the unknown phrase falls into the domain to which the target text belongs.

In the embodiment of the present disclosure, the first distance between the second word vector and a cluster center of the first clustering cluster and the second distance between the second word vector and a cluster center of the second clustering cluster are obtained, and it is determined, by comparing the first distance against the second distance, whether to identify target word vectors around the second word vector. In this way, only when the second word vector is closer to the cluster center of the first clustering cluster, it is determined whether the unknown phrase is a phrase in the domain to which the target text belongs, which further improving the accuracy of the determination of unknown phrase.

Optionally, the step S103 may include: obtaining a target similarity value indicative of similarity between each of the target word vectors and the second word vector to obtain the preset quantity of target similarity values, and obtaining a sum of the preset quantity of target similarity values; determining that the unknown phrase is the phrase in the domain to which the target text belongs in a case that the sum is greater than a preset threshold; determining that the unknown phrase is not the phrase in the domain to which the target text belongs in a case that the sum is less than the preset threshold.

In the embodiment of the present disclosure, after the preset quantity of target word vectors are obtained, a target similarity value indicative of similarity between each of the target word vectors and the second word vector is calculated, thus the preset quantity of target similarity values are obtained. A sum of the preset quantity of target similarity values is calculated. For example, the electronic device may obtain ten target word vectors closest to the second word vector, and calculate the target similarity value indicative of similarity between each of the target word vectors and the second word vector, in this way, ten target similarity values are obtained. The ten target similarity values are added up, to obtain the sum of similarity values.

Further, the sum of similarity values is compared against a preset threshold, to determine whether the unknown phrase is a phrase in the domain to which the target text belongs. If the sum of similarity values is greater than the preset threshold, it is determined that the unknown phrase is the phrase in the domain to which the target text belongs; if the sum of similarity values is less than the preset threshold, it is determined that the unknown phrase is not the phrase in the domain to which the target text belongs.

It may be understood, the sum of similarity values is derived from the similarity values indicative of similarity between all target word vectors and the second word vector, and the target word vector is a word vector closer to the second word vector, thus a greater similarity value indicative of similarity between the target word vector and the second word vector demonstrates a greater possibility that the second word vector and the target word vector belong to the same domain. The preset threshold is a threshold set in advance, and may be associated with the first word vectors, e.g., the preset threshold is a vector average of the first word vectors. The sum of similarity values being greater than the preset threshold demonstrates that the second word vector is more similar to the first word vectors, then it is determined that the unknown phrase is the phrase in the domain to which the target text belongs; the sum of similarity values being less than the preset threshold demonstrates that the second word vector is less similar to the first word vectors, then it is determined that the unknown phrase is not the phrase in the domain to which the target text belongs. In this way, it can be determined, by comparing the similarity values against the threshold, whether the unknown phrase is a phrase in the domain to which the target text belongs. The determination according to personal experience can be dispensed with. Thus, the accuracy of the identification and determination of unknown phrase is effectively improved. In addition, in this manner, the efficiency of the identification and determination of unknown phrase can be improved more accurately and effectively, thereby the efficiency of mining the phrases in the domain to which the target text belongs can be improved.

Optionally, the preset threshold is associated with a quantity of the domain-specific phrases and a quantity of the preset conventional phrases. That is, both the quantity of the domain-specific phrases and the quantity of the preset conventional phrases impact the value of the preset threshold. For example, the greater the quantity of the domain-specific phrases and the less the quantity of preset conventional phrases, the greater the preset threshold is. In this way, the identification and determination of unknown phrase is also associated with the quantity of the domain-specific phrases and the quantity of the preset conventional phrases, thereby the accuracy of the identification and determination of unknown phrase is improved.

For example, assuming there is an unknown phrase A, word vector conversion is performed on the unknown phrase A to obtain the second word vector, and n target word vectors closest to the second word vector in the word vector space are obtained, then a similarity value indicative of similarity between each target word vector and the second word vector is calculated, the obtained n similarity values are added up to obtain the sum of the similarity values, and the sum of the similarity values is compared against the preset threshold. Specific computation formulas thereof are as follows:

$$psum ( X ) = {\sum }_{i = 1}^{n} {P}_{i} * ( x ) ;$$

$$r ( x ) = \{ \begin{matrix}cosine ( x , {center}_{pos} ) \\ - 10 * cosine ( x , {center}_{neg} ) \\ 0\end{matrix} ;$$

wherein, psum(X) denotes a sum of similarity values indicative of similarity between n target word vectors and the second word vector; Pᵢ denotes similarity between the i^{th} target word vector in the n target word vectors and the second word vector; r(x) denotes a status of the second word vector, the first word vectors around the second word vector and distances between these first word vectors and the cluster center of the first clustering cluster; centerₚₒₛ denotes a vector corresponding to the cluster center of the first clustering cluster; cosine(x,centerₚₒₛ) denotes a distance between the second word vector and the cluster center of the first clustering cluster; center_{neg} denotes a vector corresponding to the cluster center of the second clustering cluster, cosine(x,center_{neg}) denotes a distance between the second word vector and the cluster center of the second clustering cluster.

It is noted, in a case that the target word vector is the first word vector, r(x)=cosine(x,centerₚₒₛ); in a case that the target word vector is the third word vector, r(x)=−10*cosine(x,center_{neg}); in a case that the target word vector is the second word vector, r(x)=0.

Optionally, the preset threshold may be calculated according to the following formulas:

$$kth ( x ) = 5.0 + 2.0 * \frac{{pos}_{size} + {neg}_{size}}{{total}_{sample}} + tth ( x ) ;$$

$$tth ( x ) = \{ \begin{matrix}3.0 * \frac{{pos}_{size}}{{pos}_{size} + {neg}_{size}} \\ 3.0 * \frac{{neg}_{size}}{{pos}_{size} + {neg}_{size}}\end{matrix} ;$$

wherein, kth(x) denotes the preset threshold, pos_{size} denotes the quantity of domain-specific phrases, neg_{size} denotes the quantity of preset conventional phrases, totalₛₐₘₚₗₑ denotes a total quantity of unknown phrases, domain-specific phrases and conventional preset phrases, tth(x) denotes a penalty coefficient.

Optionally, in a case that the target word vector is the first word vector,

$$tth ( x ) = 3.0 * \frac{{pos}_{size}}{{pos}_{size} + {neg}_{size}} ;$$

in a case that the target word vector is the third word vector,

$$tth ( x ) = 3.0 * \frac{{neg}_{size}}{{pos}_{size} + {neg}_{size}} .$$

In this way, the preset threshold is associated with both the quantity of the domain-specific phrases and the quantity of the preset conventional phrases. For example, in a case that the target word vector is the first word vector, the greater proportion the domain-specific phrases account for, the greater the penalty coefficient is, and the greater the preset threshold is. By means of such a setting, the clustering scheme provided by the present disclosure can be further constrained based on the quantity of the domain-specific phrases and the quantity of the preset conventional phrases, that is, the quantity of the domain-specific phrases and the quantity of the preset conventional phrases will impact the identification and determination as to whether the unknown phrase falls into the domain to which the target text belongs.

It is noted, in an embodiment of the present disclosure, after the identification and determination of unknown phrase is completed, an additional unknown phrase identification and determination process may be performed on the target text based on the foregoing steps, so as to mine more phrases falling into the domain to which the target text belongs, to increase the quantity of phrases in the domain to which the target text belongs, thereby facilitating the implementation of a downstream task such as text content recall, or multi-level labelling.

Optionally, the method provided in the embodiment of the present disclosure further includes: using the unknown phrase as a training positive sample of a domain-specific phrase mining model in a case that it is determined that the unknown phrase is the phrase in the domain to which the target text belongs, the training positive sample belonging to a first clustering cluster after word vector conversion is performed on the training positive sample; using the unknown phrase as a training negative sample of the domain-specific phrase mining model in a case that it is determined that the unknown phrase is not the phrase in the domain to which the target text belongs, the training negative sample belonging to a second clustering cluster after word vector conversion is performed on the training negative sample.

In the embodiment of the present disclosure, after the identification of unknown phrase is completed, the identified unknown phrase may be used as the training positive sample or training negative sample of the domain-specific phrase mining model, thereby the quantity of samples for the domain-specific phrase mining model may be increased, so as to facilitate the training of the domain-specific phrase mining model.

It is noted, the domain-specific phrase mining model is a neural network model, and for a training method of the domain-specific phrase mining model, reference may be made to the training method of neural network model in the related art. A detailed description thereof is omitted herein.

Optionally, the domain-specific phrase mining model is a twin network structure model. As shown in FIG. 2, the twin network structure model employs a three-tower structure, but the towers share network layer parameters. The anchor represents a target example. The R-Pos (relative positive sample) represents a center of examples of the same kind that correspond to the target example, if the target example is a training positive sample or a domain-specific phrase, then the corresponding examples are training positive samples, and if the target example is a training negative sample or a preset conventional phrase, then the corresponding examples are training negative samples. The R-Neg (relative negative sample) represents a center of opposite examples that correspond to the target example, if the target example is a training positive sample, then the corresponding examples are training negative samples, and if the target example is a training negative sample, then the corresponding examples are training positive samples. R (anchor, R-*) denotes cosine similarity. The cosine similarity is expressed in the following formula:

$$cosine ( A , B ) = \frac{{\sum }_{i = 1}^{n} {A}_{i} \times {B}_{i}}{\sqrt{{\sum }_{i = 1}^{n} {( {A}_{i} )}^{2} \times \sqrt{{\sum }_{i = 1}^{n} {( {B}_{i} )}^{2}}}} ;$$

wherein cosine (A, B) denotes cosine similarity between example A and example B; the network layer of the domain-specific phrase mining model uses a relu activation function, the network parameters W={w1,w2,w3}, B={b1,b2,b3}; the initialization uses a uniform distribution which has a value range of [−param_range, param_range], wherein:

$$param\_range = \sqrt{\frac{6.0}{{output}_{size} + {input}_{size}}} ;$$

where output_{size} denotes an output parameter, input_{size} denotes an input parameter.

Optionally, the domain-specific phrase mining model may use Triplet-Center Loss as the main body of the loss function. The Triplet-Center Loss may adhere to the following rule: a distance between similar examples is as small as possible; if a distance between dissimilar examples is less than a threshold, the distance is prevented from being less than the threshold by using mutual exclusion. The loss function is calculated as follows:

loss=max(margin−cosine(anchor,RPos)+cosine(anchor,RNeg),0)

wherein, margin denotes the threshold, cosine(anchor,RPos) denotes cosine similarity between the target example and the training positive sample; cosine (anchor,RNeg) denotes cosine similarity between the target example and the training negative sample.

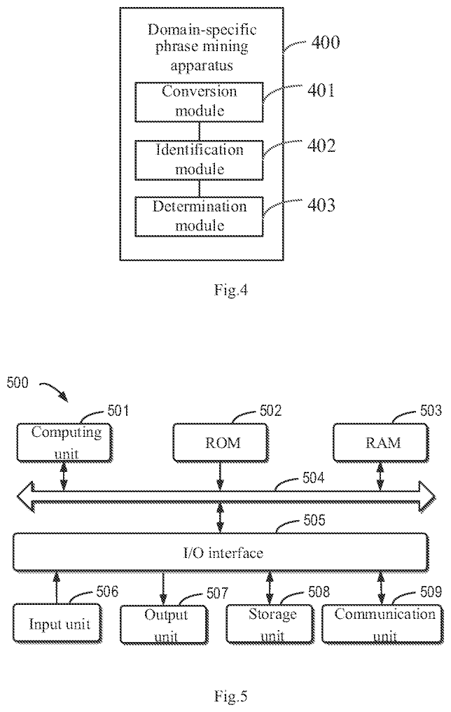

For example, in the process of constructing examples for the domain-specific phrase mining model, positive samples and negative samples are traversed to be used as the anchor, for positive samples P={p1, p2, . . . , pn} and negative samples N={n1, n2, . . . , nn}, if the anchor is a positive sample, then the most dissimilar sample in the positive sample library is taken as R-Pos, and the most similar sample in the negative sample library is taken as N-Neg; if the anchor is a negative sample, then the most dissimilar sample in the negative sample library is taken as R-Pos, and the most similar sample in the positive sample library is taken as R-Neg. As shown in FIG. 3, the anchor is 0.67 and is a positive sample, then the most dissimilar sample 0 in the positive sample library may be selected as R-Pos, and the most dissimilar sample −0.3 in the negative sample library may be selected as N-Neg. In this way, the example construction for the domain-specific phrase mining model is completed, thereby the training of the domain-specific phrase mining model is better achieved, and the accuracy of the domain-specific phrase mining model is improved.

The present disclosure further provides a domain-specific phrase mining apparatus.

Referring to FIG. 4, a structure diagram of a domain-specific phrase mining apparatus according to an embodiment of the present disclosure is illustrated. As shown in FIG. 4, the domain-specific phrase mining apparatus 400 includes: a conversion module 401, configured to perform word vector conversion on a domain-specific phrase in a target text to obtain a first word vector, and perform word vector conversion on an unknown phrase in the target text to obtain a second word vector, where the domain-specific phrase is a phrase in a domain to which the target text belongs; an identification module 402, configured to obtain a word vector space formed by the first and second word vectors, and identify a preset quantity of target word vectors around the second word vector in the word vector space; a determination module 403, configured to determine, based on similarity values indicative of similarity between the preset quantity of target word vectors and the second word vector, whether the unknown phrase is a phrase in the domain to which the target text belongs.

Optionally, the domain-specific phrase mining apparatus 400 further includes: a first obtaining module, configured to obtain a first clustering cluster formed by the first word vector, and obtain a second clustering cluster formed by a third word vector converted from a preset conventional phrase; a second obtaining module, configured to obtain a first distance between the second word vector and a cluster center of the first clustering cluster, and obtain a second distance between the second word vector and a cluster center of the second clustering cluster.

The identification module 402 is further configured to: identify the preset quantity of target word vectors around the second word vector in the word vector space in a case that the first distance is less than the second distance.

Optionally, the determination module 403 is further configured to: obtain a target similarity value indicative of similarity between each of the target word vectors and the second word vector to obtain the preset quantity of target similarity values, and obtain a sum of the preset quantity of target similarity values; determine that the unknown phrase is the phrase in the domain to which the target text belongs in a case that the sum is greater than a preset threshold; determine that the unknown phrase is not the phrase in the domain to which the target text belongs in a case that the sum is less than the preset threshold.

Optionally, the preset threshold is associated with a quantity of the domain-specific phrases and a quantity of preset conventional phrases.

Optionally, the determination module 403 is further configured to: use the unknown phrase as a training positive sample of a domain-specific phrase mining model in a case that it is determined that the unknown phrase is the phrase in the domain to which the target text belongs, the training positive sample belonging to a first clustering cluster after word vector conversion is performed on the training positive sample; use the unknown phrase as a training negative sample of the domain-specific phrase mining model in a case that it is determined that the unknown phrase is not the phrase in the domain to which the target text belongs, the training negative sample belonging to a second clustering cluster after word vector conversion is performed on the training negative sample; wherein the domain-specific phrase mining model is a twin network structure model.

It is noted, the domain-specific phrase mining apparatus 400 provided in the embodiment can implement all technical solutions of the embodiment of the foregoing domain-specific phrase mining method, and thus can at least achieve all the aforementioned technical effects. A detailed description thereof is omitted herein.

According to embodiments of the present disclosure, the present disclosure further provides an electronic device, a readable storage medium and a computer program product.

Referring to FIG. 5, a schematic block diagram of an exemplary electronic device 500 for implementing the embodiments of the present disclosure is illustrated. The electronic device is intended to represent various forms of digital computers, such as laptop computer, desktop computer, workstation, personal digital assistant, server, blade server, mainframe and other suitable computers. The electronic device may represent various forms of mobile devices as well, such as personal digital processing device, cellular phone, smart phone, wearable device and other similar computing devices. The components, the connections and relationships therebetween and the functions thereof described herein are merely exemplary, and are not intended to limit the implementation of this disclosure described and/or claimed herein.

As shown in FIG. 5, the device 500 includes a computing unit 501. The computing unit 501 may carry out various suitable actions and processes according to a computer program stored in a read-only memory (ROM) 502 or a computer program loaded from a storage unit 508 into a random access memory (RAM) 503. The RAM 503 may as well store therein all kinds of programs and data required for the operation of the device 500. The computing unit 501, the ROM 502 and the RAM 503 are connected to each other through a bus 504. An input/output (I/O) interface 505 is also connected to the bus 504.

Multiple components in the device 500 are connected to the I/O interface 505. The multiple components include: an input unit 506, e.g., a keyboard, a mouse and the like; an output unit 507, e.g., a variety of displays, loudspeakers, and the like; a storage unit 508, e.g., a magnetic disk, an optical disc and the like; and a communication unit 509, e.g., a network card, a modem, a wireless transceiver, and the like. The communication unit 509 allows the device 500 to exchange information/data with other devices through a computer network, such as the Internet, and/or other telecommunication networks.

The computing unit 501 may be any general purpose and/or special purpose processing components having a processing and computing capability. Some examples of the computing unit 501 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 501 carries out the aforementioned methods and processes, e.g., the domain-specific phrase mining method. For example, in some embodiments, the domain-specific phrase mining method may be implemented as a computer software program tangibly embodied in a machine readable medium, such as the storage unit 508. In some embodiments, all or a part of the computer program may be loaded to and/or installed on the device 500 through the ROM 502 and/or the communication unit 509. When the computer program is loaded into the RAM 503 and executed by the computing unit 501, one or more steps of the foregoing domain-specific phrase mining method may be implemented. Optionally, in other embodiments, the computing unit 501 may be configured in any other suitable manner (e.g., by means of a firmware) to implement the domain-specific phrase mining method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN), and the Internet.

The computer system can include a client and a server. The client and server are generally remote from each other and typically interact through a communication network. The relationship of client and server arises by virtue of computer programs running on respective computers and having a client-server relationship to each other.

It is appreciated, all forms of processes shown above may be used, and steps thereof may be reordered, added or deleted. For example, as long as expected results of the technical solutions of the present application can be achieved, steps set forth in the present application may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A domain-specific phrase mining method comprising:
performing word vector conversion on a domain-specific phrase in a target text to obtain a first word vector, and performing word vector conversion on an unknown phrase in the target text to obtain a second word vector, wherein the domain-specific phrase is a phrase in a domain to which the target text belongs;
obtaining a word vector space formed by the first word vector and the second word vector, and identifying a preset quantity of target word vectors around the second word vector in the word vector space; and
determining, based on similarity values indicative of a similarity between the preset quantity of target word vectors and the second word vector, whether the unknown phrase is a phrase in the domain to which the target text belongs.

2. The domain-specific phrase mining method according to claim 1, further comprising
obtaining a first clustering cluster formed by the first word vector, and obtaining a second clustering cluster formed by a third word vector converted from a preset conventional phrase; and
obtaining a first distance between the second word vector and a cluster center of the first clustering cluster, and obtaining a second distance between the second word vector and a cluster center of the second clustering cluster,
wherein identifying the preset quantity of target word vectors around the second word vector in the word vector space comprises:
identifying the preset quantity of target word vectors around the second word vector in the word vector space in a case that the first distance is less than the second distance.

3. The domain-specific phrase mining method according to claim 1, wherein determining, based on the similarity values indicative of the similarity between the preset quantity of target word vectors and the second word vector, whether the unknown phrase is the phrase in the domain to which the target text belongs comprises:
obtaining a target similarity value indicative of a similarity between each of the preset quantity of target word vectors and the second word vector to obtain a preset quantity of target similarity values, and obtaining a sum of the preset quantity of target similarity values;
determining that the unknown phrase is the phrase in the domain to which the target text belongs in a case that the sum is greater than a preset threshold; and
determining that the unknown phrase is not the phrase in the domain to which the target text belongs in a case that the sum is less than the preset threshold.

4. The domain-specific phrase mining method according to claim 3, wherein the preset threshold is associated with a quantity of domain-specific phrases and a quantity of preset conventional phrases.

5. The domain-specific phrase mining method according to claim 1, further comprising:
using the unknown phrase as a training positive sample of a domain-specific phrase mining model in a case that it is determined that the unknown phrase is the phrase in the domain to which the target text belongs, wherein the training positive sample belongs to a first clustering cluster after word vector conversion is performed on the training positive sample; and
using the unknown phrase as a training negative sample of the domain-specific phrase mining model in a case that it is determined that the unknown phrase is not the phrase in the domain to which the target text belongs, wherein the training negative sample belongs to a second clustering cluster after word vector conversion is performed on the training negative sample,
wherein the domain-specific phrase mining model is a twin network structure model.

6. An electronic device comprising:
at least one processor; and
a memory in communicative connection with the at least one processor,
wherein the memory stores instructions executable by the at least one processor, and the instructions, when executed by the at least one processor, cause the at least one processor to implement:
performing word vector conversion on a domain-specific phrase in a target text to obtain a first word vector, and performing word vector conversion on an unknown phrase in the target text to obtain a second word vector, wherein the domain-specific phrase is a phrase in a domain to which the target text belongs;
obtaining a word vector space formed by the first word vector and the second word vectors, and identifying a preset quantity of target word vectors around the second word vector in the word vector space; and
determining, based on similarity values indicative of a similarity between the preset quantity of target word vectors and the second word vector, whether the unknown phrase is a phrase in the domain to which the target text belongs.

7. The electronic device according to claim 6, wherein the instructions, when executed by the at least one processor, cause the at least one processor to further implement:
obtaining a first clustering cluster formed by the first word vector, and obtaining a second clustering cluster formed by a third word vector converted from a preset conventional phrase; and
obtaining a first distance between the second word vector and a cluster center of the first clustering cluster, and obtaining a second distance between the second word vector and a cluster center of the second clustering cluster,
wherein the instructions, when executed by the at least one processor, cause the at least one processor to further implement:
identifying the preset quantity of target word vectors around the second word vector in the word vector space in a case that the first distance is less than the second distance.

8. The electronic device according to claim 6, wherein the instructions, when executed by the at least one processor, cause the at least one processor to further implement:
obtaining a target similarity value indicative of a similarity between each of the preset quantity of target word vectors and the second word vector to obtain a preset quantity of target similarity values, and obtaining a sum of the preset quantity of target similarity values;
determining that the unknown phrase is the phrase in the domain to which the target text belongs in a case that the sum is greater than a preset threshold; and
determining that the unknown phrase is not the phrase in the domain to which the target text belongs in a case that the sum is less than the preset threshold.

9. The electronic device according to claim 8, wherein the preset threshold is associated with a quantity of domain-specific phrases and a quantity of preset conventional phrases.

10. The electronic device according to claim 6, wherein the instructions, when executed by the at least one processor, cause the at least one processor to further implement:
using the unknown phrase as a training positive sample of a domain-specific phrase mining model in a case that it is determined that the unknown phrase is the phrase in the domain to which the target text belongs, wherein the training positive sample belongs to a first clustering cluster after word vector conversion is performed on the training positive sample; and
using the unknown phrase as a training negative sample of the domain-specific phrase mining model in a case that it is determined that the unknown phrase is not the phrase in the domain to which the target text belongs, wherein the training negative sample belongs to a second clustering cluster after word vector conversion is performed on the training negative sample,
wherein the domain-specific phrase mining model is a twin network structure model.

11. A non-transitory computer-readable storage medium storing thereon computer instructions, wherein the computer instructions are configured to be executed by a computer to implement:
performing word vector conversion on a domain-specific phrase in a target text to obtain a first word vector, and performing word vector conversion on an unknown phrase in the target text to obtain a second word vector, wherein the domain-specific phrase is a phrase in a domain to which the target text belongs;
obtaining a word vector space formed by the first word vector and the second word vectors, and identifying a preset quantity of target word vectors around the second word vector in the word vector space; and
determining, based on similarity values indicative of similarity between the preset quantity of target word vectors and the second word vector, whether the unknown phrase is a phrase in the domain to which the target text belongs.

12. The non-transitory computer-readable storage medium according to claim 11, wherein the computer instructions are configured to be executed by the computer to further implement:
obtaining a first clustering cluster formed by the first word vector, and obtaining a second clustering cluster formed by a third word vector converted from a preset conventional phrase; and
obtaining a first distance between the second word vector and a cluster center of the first clustering cluster, and obtaining a second distance between the second word vector and a cluster center of the second clustering cluster,
wherein the computer instructions are configured to be executed by the computer to implement:
identifying the preset quantity of target word vectors around the second word vector in the word vector space in a case that the first distance is less than the second distance.

13. The non-transitory computer-readable storage medium according to claim 11, wherein the computer instructions are configured to be executed by the computer to further implement:
obtaining a target similarity value indicative of similarity between each of the preset quantity of target word vectors and the second word vector to obtain a preset quantity of target similarity values, and obtaining a sum of the preset quantity of target similarity values;
determining that the unknown phrase is the phrase in the domain to which the target text belongs in a case that the sum is greater than a preset threshold; and
determining that the unknown phrase is not the phrase in the domain to which the target text belongs in a case that the sum is less than the preset threshold.

14. The non-transitory computer-readable storage medium according to claim 13, wherein the preset threshold is associated with a quantity of domain-specific phrases and a quantity of preset conventional phrases.

15. The non-transitory computer-readable storage medium according to claim 11, wherein the computer instructions are configured to be executed by the computer to further implement:
using the unknown phrase as a training positive sample of a domain-specific phrase mining model in a case that it is determined that the unknown phrase is the phrase in the domain to which the target text belongs, wherein the training positive sample belongs to a first clustering cluster after word vector conversion is performed on the training positive sample; and
using the unknown phrase as a training negative sample of the domain-specific phrase mining model in a case that it is determined that the unknown phrase is not the phrase in the domain to which the target text belongs, wherein the training negative sample belongs to a second clustering cluster after word vector conversion is performed on the training negative sample,
wherein the domain-specific phrase mining model is a twin network structure model.

16. A computer program product comprising a computer program, wherein the computer program is configured to be executed by a processor to implement the method according to claim 1.

17. The computer program product according to claim 16, wherein the computer program is configured to be executed by the processor to implement:
obtaining a first clustering cluster formed by the first word vector, and obtaining a second clustering cluster formed by a third word vector converted from a preset conventional phrase; and
obtaining a first distance between the second word vector and a cluster center of the first clustering cluster, and obtaining a second distance between the second word vector and a cluster center of the second clustering cluster,
wherein the computer program is configured to be executed by the processor to implement:
identifying the preset quantity of target word vectors around the second word vector in the word vector space in a case that the first distance is less than the second distance.

18. The computer program product according to claim 16, wherein the computer program is configured to be executed by the processor to implement:
obtaining a target similarity value indicative of similarity between each of the preset quantity of target word vectors and the second word vector to obtain a preset quantity of target similarity values, and obtaining a sum of the preset quantity of target similarity values;
determining that the unknown phrase is the phrase in the domain to which the target text belongs in a case that the sum is greater than a preset threshold; and
determining that the unknown phrase is not the phrase in the domain to which the target text belongs in a case that the sum is less than the preset threshold.

19. The computer program product according to claim 18, wherein the preset threshold is associated with a quantity of domain-specific phrases and a quantity of preset conventional phrases.

20. The computer program product according to claim 16, wherein the computer program is configured to be executed by the processor to implement:
using the unknown phrase as a training positive sample of a domain-specific phrase mining model in a case that it is determined that the unknown phrase is the phrase in the domain to which the target text belongs, wherein the training positive sample belongs to a first clustering cluster after word vector conversion is performed on the training positive sample; and
using the unknown phrase as a training negative sample of the domain-specific phrase mining model in a case that it is determined that the unknown phrase is not the phrase in the domain to which the target text belongs, wherein the training negative sample belongs to a second clustering cluster after word vector conversion is performed on the training negative sample,
wherein the domain-specific phrase mining model is a twin network structure model.
